(19) United States
(12) Patent Application Publication
(10) Pub. No.: US 2024/0178707 A1
(43) Pub. Date: May 30, 2024

(54) CHARGING METHOD AND APPARATUS

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/552,060

(22) PCT Filed: Mar. 22, 2021
(86) PCT No.: PCT/CN2021/082131

§ 371 Date: Sep. 22, 2023

(51) Int. Cl. H02J 50/80; H02J 7/00; H04W 76/27

(52) U.S. Cl. CPC H02J 50/80; H02J 7/00032; H04W 76/27

(57) ABSTRACT

The present disclosure relates to a charging method. The charging method comprises: sending a wireless charging request to a base station to request the base station to wirelessly charge a terminal.

### CROSS REFERENCE TO RELATED APPLICATIONS

This application is a National Stage of International Application No. PCT/CN2021/082131, filed on Mar. 22, 2021, the disclosure of which is incorporated herein by reference in its entirety for all purposes.

### BACKGROUND

With the development of mobile communications, terminals, such as notebook computers, tablet computers, and mobile phones, have more and more functions, thereby providing a lot of convenience to the life of people.

### SUMMARY

The present disclosure relates to the technical field of communication, in particular to a charging method and apparatus, an electronic device, and a computer-readable storage medium.

According to a first aspect of the embodiments of the present disclosure, provided is a charging method performed by a terminal, and the method includes: sending a wireless charging request to a base station to request the base station to perform wireless charging on the terminal.

According to a second aspect of the embodiments of the present disclosure, provided is a charging apparatus applied to a terminal, and the apparatus includes: a charging request module configured to send a wireless charging request to a base station to request the base station to perform wireless charging on the terminal.

According to a third aspect of the embodiments of the present disclosure, provided is a charging method performed by a base station, and the method includes: receiving a wireless charging request sent by a terminal, and performing wireless charging on the terminal.

### BRIEF DESCRIPTION OF DRAWINGS

To describe the technical solutions in the embodiments of the present disclosure more clearly, the accompanying drawings required for describing the embodiments will be briefly introduced below. Apparently, the accompanying drawings in the following description show only some embodiments of the present disclosure, and those of ordinary skill in the art may still derive other accompanying drawings from these accompanying drawings without creative work.

FIG. 1 is a schematic process diagram of a charging method shown according to an embodiment of the present disclosure;

FIG. 2 is a schematic process diagram of another charging method shown according to an embodiment of the present disclosure;

FIG. 3 is a schematic process diagram of another charging method shown according to an embodiment of the present disclosure;

FIG. 4 is a schematic process diagram of a charging method shown according to an embodiment of the present disclosure;

FIG. 5 is a schematic block diagram of a charging apparatus shown according to an embodiment of the present disclosure;

FIG. 6 is a schematic block diagram of another charging apparatus shown according to an embodiment of the present disclosure;

FIG. 7 is a schematic block diagram of an apparatus for charging shown according to an embodiment of the present disclosure; and

FIG. 8 is a schematic block diagram of an apparatus for charging shown according to an embodiment of the present disclosure.

### DETAILED DESCRIPTION

The technical solutions in the embodiments of the present disclosure will be described clearly and completely below in conjunction with the accompanying drawings in the embodiments of the present disclosure. Apparently, the described embodiments are a part of the embodiments of the present disclosure, not all the embodiments. Based on the embodiments of the present disclosure, all other embodiments obtained by those of ordinary skill in the art without creative work shall fall within the protective scope of the present disclosure.

In mobile communications, in order to ensure portability, batteries with higher capacity are usually not configured for the terminals, and insufficient battery life has been plaguing manufacturers and consumers. In the current situation that mobile terminals have larger and larger screens and more and more functions, how to charge the terminals conveniently and efficiently has become urgent.

With the development of mobile communications, wireless charging has been favored by the majority of users due to its convenience. In related art, the wireless charging may usually include three technologies which are respectively an electromagnetic induction technology, an electromagnetic resonance technology, and a radio frequency technology.

An air charging technology based on radio frequency technology has attracted more and more attention. In this technology, a spatial electric field is used as a medium for energy transmission. For example, a charging device may transfer energy to a terminal by a large number of antennae in a form of millimeter-wave extremely narrow beams, the terminal may receive the energy by micro-beacon antennae, and thus, long-distance wireless charging is achieved.

In an embodiment, with the development of a cellular mobile communication technology, especially the development of a millimeter-wave communication technology, a terminal may also achieve wireless charging by cellular mobile communication. For example, a key technology in a 5G communication technology is a Massive MIMO technology with large-scale antennae. In this technology, a base station is usually equipped with large-scale antennae, which also lays a foundation for the base station to perform wireless charging on the terminal through a cellular network.

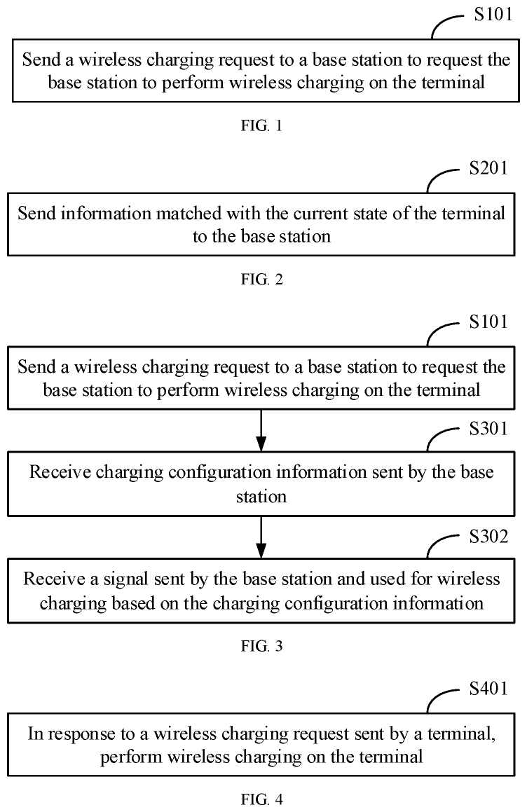

FIG. 1 is a schematic process diagram of a charging method shown according to an embodiment of the present disclosure. The charging method shown in the present embodiment is applicable to a terminal, and the terminal includes, but is not limited to an electronic device, such as a mobile phone, a tablet computer, a wearable device, a sensor, and an Internet-of-things device. The terminal may be used as user equipment to communicate with a base station, and the base station includes, but is not limited to a 4G base station, a 5G base station, and a 6G base station. In an embodiment, the base station may be a base station applicable to the charging method in any one of subsequent embodiments.

As shown in FIG. 1, the charging method may include the following steps:

in step S101, a wireless charging request is sent to a base station to request the base station to perform wireless charging on the terminal.

In an embodiment, the terminal may determine whether it needs to be charged according to its own use state. The use state may include residual power, a load condition, etc. For example, the terminal may preset a power threshold (such as 30%), a load threshold (such as 60%), etc.; when the residual power is less than this power threshold, the terminal determines that it needs to be charged; or when a load of the terminal exceeds a preset load threshold, the terminal determines that it is not charged to avoid use abnormity due to excessive load. The load condition of the terminal may include use rates, etc. of an internal memory and a CPU. Or, the terminal may also include other use states, and the terminal may determine whether it needs to be charged in consideration of a plurality of use states as a whole.

Therefore, the terminal may independently judge whether it needs to be charged, and may be actively charged without a user's perception, which not only ensures the timeliness of charging, but also brings convenience to the user and improves user experience.

In an embodiment, the terminal may also determine, according to an instruction from a user, whether it needs to be charged. For example, the terminal may display a charging interface to the user by means of a client interface, and thus, the user indicates, according to this charging interface, that the terminal needs to be charged; or, a mechanical structure for charging, such as a charging button may be provided on the terminal, and thus, the user presses this charging button to indicate that the terminal needs to be charged.

It needs to be noted that the above-mentioned method for judging whether the terminal needs to be charged is only an illustrative example. In practical applications, other methods may also be included to make judgments, which is not limited in the present embodiment.

In an embodiment, when determining that wireless charging is needed, the terminal may actively send the wireless charging request to the base station to request the base station to perform wireless charging on the terminal.

In an embodiment, after receiving the wireless charging request sent by this terminal, the base station may perform wireless charging on this terminal. For example, the base station may determine, according to the current state of the base station, such as the current antenna use condition and/or load condition of the base station, whether to perform wireless charging on the terminal.

According to the embodiment shown in FIG. 1, the terminal may actively send the wireless charging request to the base station, so that the base station may perform wireless charging on the terminal after receiving this wireless charging request. Compared with traditional “wireless charging” methods, the terminal is not required to be in close contact with a charging device, but realizes air charging by means of the base station at a relatively far distance, thereby improving user experience and bringing great convenience.

In addition, compared with wireless charging performed by other charging devices other than the base station, because the terminal usually needs to be connected to the base station during use, on this basis, the terminal requests wireless charging from the connected base station, and thus, it is unnecessary to connect the terminal to other devices, which simplifies the connection of the terminal and saves the performances of the terminal.

FIG. 2 is a schematic process diagram of another charging method shown according to an embodiment of the present disclosure. As shown in FIG. 2, the step of sending the wireless charging request to the base station includes:

in step S201, information matched with the current state of the terminal is sent to the base station, wherein the information carries the wireless charging request.

In an embodiment, the terminal may include a plurality of current states, such as an IDLE state, a CONNECTED state, and an INACTIVE state. When being in the different states, there may be different interaction processes between the terminal and the base station. For example, the terminal in the IDLE state or the INACTIVE state may initiate a random access process to the base station, and the terminal in the CONNECTED state may send an RRC message, etc. to the base station.

In an embodiment, implementation of the wireless charging request of the terminal may be on the basis of improvement of an existing process of interaction between the terminal with the base station. In an example, the terminal may carry the wireless charging request, for example, a relevant identification for requesting wireless charging, in the request information sent to the base station in an existing interaction process. That is, the implementation of the wireless charging request of the terminal may be achieved on the basis of the improvement of the existing request information without defining new request information, so that the process is simple, and system resources are saved. Or, in another example, the terminal may also introduce new request information to the existing interaction process, for example, defining a signaling dedicated to the wireless charging request, which is not repeated herein.

Specifics embodiments that the terminal sends the wireless charging request to the base station according to the different states of the terminal will be introduced respectively below.

In an embodiment, the terminal may be in the IDLE state or the INACTIVE state. In the related art, the terminal in the IDLE state or the INACTIVE state may initiate a random access request to the base station; and if the random access request is successful, the terminal may enter the CONNECTED state. In an embodiment, the wireless charging request of the terminal may be achieved by means of this random access request.

In an embodiment, the step of sending the information matched with the current state of the terminal to the base station includes: in response to the terminal being in an IDLE state or an INACTIVE state, a specified preamble is sent to the base station, wherein the specified preamble is used for indicating the base station to perform wireless charging on the terminal.

In an embodiment, the terminal may send the specified preamble to the base station, and this specified preamble may be used for indicating the base station to perform wireless charging on the terminal. For example, the terminal may carry one or more bytes for requesting wireless charging in this specified preamble, for example, carrying a wireless charging request identification in a reserved position in the existing preamble.

In an example, the step of sending a specified preamble to the base station includes: a first message in a random access process carrying the specified preamble is sent to the base station. For example, this first message may be a message 1 in a random access process (Msg1), and the terminal may send the message 1 to the base station, and the above-mentioned specified preamble for indicating the wireless charging for the terminal is carried in this message 1. Or, in another example, the terminal may also carry this specified preamble by means of other existing information or by defining new information instead of utilizing the message 1.

It should be noted that the base station and the terminal may pre-negotiate how to define this specified preamble, or the base station may also define this specified preamble according to stipulations of a protocol as long as a manner that the terminal generates the specified preamble is consistent with a manner that the base station parses the preamble, and the specific implementation is not limited herein.

In an embodiment, the step of sending the information matched with the current state of the terminal to the base station may include: in response to the terminal being in an IDLE state or an INACTIVE state, a second message in a random access process is sent to the base station.

In an embodiment, the second message may be a message 3 in a random access process (Msg3), and the terminal may carry the wireless charging request by means of the message 3.

In an embodiment, there may be a different second message according to different states of the terminal and different application scenarios. For example, in response to the terminal being in the IDLE state, the second message may be RRCSetupRequest or RRCReestablishmentRequest. For example, when the terminal in the IDLE state is initially connected to the base station, the RRCSetupRequest may be usually used as the second message; or when the terminal is in connection re-establishment, RRCReestablishmentRequest may be usually used as the second message.

Or, in response to the terminal being in the INACTIVE state, the second message may be RRCResumeRequest. For example, when the terminal in the INACTIVE state is resumed to be connected to the base station, the RRCResumeRequest may be usually used as the second message.

In an embodiment, this second message may also be other relevant messages rather than the message 3, which is not limited in the present embodiment.

In an embodiment, the step of sending the information matched with the current state of the terminal to the base station may include: in response to the terminal being in an IDLE state or an INACTIVE state, a third message in a random access process is sent to the base station.

In an embodiment, the third message may be a message 5 in a random access process (Msg5), and the terminal may carry the wireless charging request by means of the message 5 (Msg5).

For example, in response to the terminal being in the IDLE state, the third message may be RRCSetupComplete or RRCReestablishmentComplete; or, in response to the terminal being in the INACTIVE state, the third message is RRCResumeComplete.

In an embodiment, this third message may also be other relevant messages rather than the message 5, which is not limited in the present embodiment.

It should be noted that the message in the random access process sent in the above-mentioned embodiments does not necessarily mean that the terminal requests random access to the base station, but that the wireless charging request of the terminal is achieved based on this existing random access process. That is, the terminal may only request wireless charging for the terminal by means of the above-mentioned message in the random access process, but does not request random access. Based on this, the base station may send one or more of the first message, the second message and the third message separately without performing a complete interaction process for the random access. For example, it is possible that the first message is not sent, but the second message is directly sent, or the first message and the second message are not sent, but the third message is directly sent.

Of course, the terminal may also request random access and wireless charging at the same time by means of the above-mentioned messages in the random access process, so that the interaction efficiency is increased, and signaling overheads are reduced. Based on this, the terminal may send the above-mentioned messages according to a complete interaction process for the random access, for example, the terminal may send the first message, the second message and the third message, and carry the wireless charging request in the one or more messages, and the specific implementation details may be determined by the terminal according to actual conditions, but is not limited in the present embodiment.

In an embodiment, the terminal may be in the CONNECTED state. In the related art, an RRC (Radio Resource Control) connection has been established between the terminal in the CONNECTED state and the base station, and an RRC message may be sent to the base station.

In an embodiment, the step of sending the information matched with the current state of the terminal to the base station includes: in response to the terminal being in a CONNECTED state, an RRC message carrying the wireless charging request is sent to the base station.

In an example, the terminal may send the wireless charging request based on the existing RRC message. For example, this existing RRC message may be UEAssistanceInformation. For example, the terminal may carry a relevant identification for wireless charging in the UEAssistanceInformation, and thus, the base station may determine, according to this identification, that the terminal requests wireless charging.

In an example, the terminal may introduce new information to send the wireless charging request. For example, the terminal may define target information for carrying the wireless charging request, for example, defining a RadioChargingRequest signaling for the wireless charging request.

In an embodiment, after the terminal sends the wireless charging request to the base station, the base station may perform wireless charging on the terminal based on the current state. In an example, the base station may further determine charging configuration information according to the current state, and send this charging configuration information to the terminal. The following description is given in conjunction with FIG. 3.

FIG. 3 is a schematic process diagram of another charging method shown according to an embodiment of the present disclosure. As shown in FIG. 3, the method further includes:
in step S301, charging configuration information sent by the base station is received; and
in step S302, a signal sent by the base station and used for wireless charging is received based on the charging configuration information.

In an embodiment, after receiving the wireless charging request sent by the terminal, the base station may determine, based on the current state, whether to perform wireless charging on the terminal. The current state may include at least one of an antenna use condition of the base station and a load condition of the base station.

In an example, if the base station determines to perform wireless charging on the terminal according to the current state, the base station may further determine the charging configuration information on wireless charging for the terminal according to the current state. For example, the charging configuration information may include at least one of antenna information for wireless charging, time information for wireless charging, and power for wireless charging. Therefore, the base station may send this charging configuration information to the terminal, and perform wireless charging on the terminal based on this charging configuration information.

In an embodiment, the terminal may receive the charging configuration information sent by the base station, and the terminal may determine the configuration of wireless charging by parsing this charging configuration information, thereby receiving, based on this configuration, a signal sent by the base station to perform wireless charging.

For example, the terminal may determine, according to this charging configuration information, antennae used by the base station for wireless charging, and determine receiving antennae matched with the antennae used by the base station from a plurality of set receiving antennae (such as beacon antennae), thereby receiving, by the determined receiving antennae, the signal sent by the base station to perform wireless charging; or, the terminal may determine, according to this charging configuration information, the time for wireless charging performed by the base station, such as start time and end time, and thus, the terminal may receive the signal within a charging time specified by the base station, so that wireless charging is performed; or, the terminal may determine, according to this charging configuration information, the power for wireless charging performed by the base station, and thus, the terminal may adopt adaptive power to receive the charging signal sent by the base station, so that wireless charging is performed.

FIG. 4 is a schematic process diagram of a charging method shown according to an embodiment of the present disclosure. The charging method shown in the present embodiment is applicable to a base station, and the base station includes, but is not limited to a 4G base station, a 5G base station, and a 6G base station. The base station may communicate with a terminal used as user equipment, and the terminal includes, but is not limited to an electronic device, such as a mobile phone, a tablet computer, a wearable device, a sensor, and an Internet-of-things device. In an embodiment, the terminal may be a terminal applicable to the charging method in any one of above-mentioned embodiments.

As shown in FIG. 4, the charging method may include the following steps:

in step S401, in response to a wireless charging request sent by a terminal, wireless charging is performed on the terminal.

In an embodiment, after receiving the wireless charging request sent by the terminal, the base station may perform wireless charging on this terminal.

the method that the base station performs wireless charging on the terminal may be: sending a signal for wireless charging to the terminal by means of a plurality of antennae, specifically refers to a wireless charging method in the related art, and will not be repeated in the present embodiment.

In an embodiment, after receiving this wireless charging request, the base station does not necessarily perform wireless charging on this terminal. For example, the base station firstly needs to determine whether it has a wireless charging ability. Further, the base station may determine, based on the current state of the present base station, whether to perform wireless charging on the terminal.

In an embodiment, the current state of the base station may include at least one of: an antenna use condition of the base station and a load condition of the base station.

The antenna use condition of the base station may include the number of current spare antennae of the base station, or may also include the number of antennae capable of sending signals to this terminal for a long time. The load condition of the base station may be determined according to the number of users served by the base station at present, a current load of the base station, the number of spare channels of the base station, etc. It may be specifically determined according to actual conditions, but is not limited in the present embodiment.

In an embodiment, if the base station determines to perform wireless charging on the terminal, for example, in a case that the antenna use condition and the load condition of the base station both satisfy preset conditions, the terminal may determine the charging configuration information on wireless charging for the terminal based on the current state of the base station, and wireless charging is performed on the terminal based on the charging configuration information.

In an embodiment, the charging configuration information includes at least one of antenna information for wireless charging, time information for wireless charging, and power for wireless charging.

For example, the base station may determine, according to the number of the spare antennae, that a plurality of antennae may be used for wireless charging for the terminal. For example, the base station may determine the power for wireless charging according to the capacity and charging ability (such as the supported maximum current) of a battery of the terminal, or the base station may further estimate the time for wireless charging, etc.

In an embodiment, the base station may send the charging configuration information to the terminal to indicate the terminal to receive, based on the charging configuration information, the signal sent by the base station.

This charging configuration information may be an RRC signaling, an MAC signaling or a PHY signaling, etc., which is not limited in the present embodiment. There may be various methods that the base station sends the charging configuration information to the terminal, for example, the method may be at least one of the following methods:
an RRCReconfiguration signaling carrying the charging configuration information is sent to the terminal;
an RRCSetupComplete signaling carrying the charging configuration information is sent to the terminal;
an RRCReestablishmentComplete signaling carrying the charging configuration information is sent to the terminal; and
an RRCResumeComplete signaling carrying the charging configuration information is sent to the terminal.

In an embodiment, if the antenna use condition or load condition of the base station does not satisfy the preset conditions, the base station may determine not to perform wireless charging on the terminal. For example, in response to the current state being that the number of spare antennae of the base station is less than a preset number threshold, it is determined that wireless charging is not performed on the terminal; or, in response to the current state being that a load of the base station is greater than a preset load threshold, it is determined that wireless charging is not performed on the terminal.

In an embodiment, the method that the base station performs wireless charging on the terminal may also be implemented by indicating other base stations to perform wireless charging on the terminal. For example, the base station requested for wireless charging for the terminal may be a macro base station, and due to a possibly farther distance between the macro base station and the terminal, the transmission loss of the signal is higher. Therefore, in order to increase the charging efficiency and reduce the energy consumption, this macro base station may indicate a micro base station closer to this terminal to perform wireless charging on the terminal. For example, the base station may determine the micro base station near this terminal according to a measurement report of the terminal, and indicate this micro base station to perform wireless charging on the terminal.

In an embodiment, if determining not to perform wireless charging on the terminal, the base station may return a reply message to the terminal and refuse to perform wireless charging on the terminal.

In an embodiment, if determining not to perform wireless charging on the terminal, the base station may indicate the terminal to perform wireless charging by other adjacent base stations, for example, the base station may switch the terminal to an adjacent base station to perform wireless charging.

For example, the base station may filter out the adjacent base station not only satisfying a wireless charging condition, but also satisfying a terminal residing condition, and then switch the terminal to this adjacent base station. For example, the base station may firstly determine one or more candidate adjacent base stations satisfying the terminal residing condition, for example, the determination may be made according to the measurement report of the terminal; then, a query request may be sent to the plurality of candidate adjacent base stations, that is, it is queried whether the adjacent base stations may perform wireless charging on the terminal; and if there is a target adjacent base station capable of performing wireless charging on the terminal, the base station indicates the terminal to be switched to this target adjacent base station.

In an embodiment, the base station may directly indicate the target adjacent base station to perform wireless charging on the terminal, so that a process of interaction between the terminal and the target adjacent base station is simplified; or the base station may also switch the terminal to this adjacent base station, and then, the terminal independently requests wireless charging from the target adjacent base station. It should be noted that the target adjacent base station may be such as a macro base station, a micro base station, or a base station in other forms, which is not limited in the present embodiment.

In correspondence to the embodiment of the aforementioned charging method, the present disclosure further provides an embodiment of a charging apparatus.

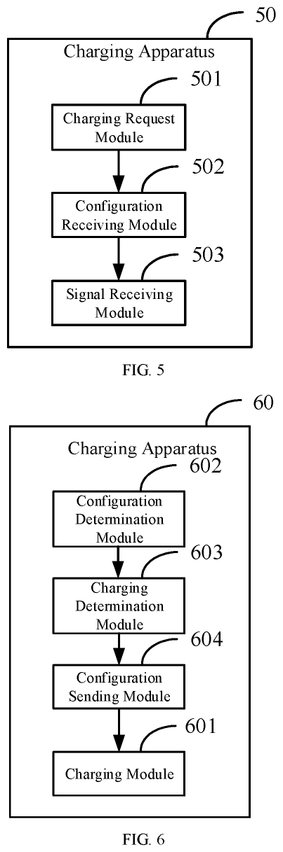

FIG. 5 is a schematic block diagram of a charging apparatus shown according to an embodiment of the present disclosure. The charging apparatus shown in the present embodiment is applicable to a terminal, and the terminal includes, but is not limited to an electronic device, such as a mobile phone, a tablet computer, a wearable device, a sensor, and an Internet-of-things device. The terminal may be used as user equipment to communicate with a base station, and the base station includes, but is not limited to a 4G base station, a 5G base station, and a 6G base station. In an embodiment, the base station may be a base station applicable to the charging apparatus in any one of subsequent embodiments.

As shown in FIG. 5, the charging apparatus 50 may include:

a charging request module 501 configured to send a wireless charging request to a base station to request the base station to perform wireless charging on the terminal.

In an embodiment, the sending a wireless charging request to a base station includes: sending information matched with the current state of the terminal to the base station, wherein the information carries the wireless charging request.

In an embodiment, the sending information matched with the current state of the terminal to the base station includes: determining the terminal being in an IDLE state or an INACTIVE state, and sending a specified preamble to the base station, wherein the specified preamble is configured to indicate the base station to perform wireless charging on the terminal.

In an embodiment, the sending a specified preamble to the base station includes: sending a first message in a random access process carrying the specified preamble to the base station.

In an embodiment, the sending information matched with the current state of the terminal to the base station includes: determining the terminal being in an IDLE state or an INACTIVE state, and sending a second message in a random access process to the base station.

In an embodiment, the terminal is in the IDLE state, and the second message is RRCSetupRequest or RRCReestablishmentRequest; or, the terminal is in the INACTIVE state, and the second message is RRCResumeRequest.

In an embodiment, the sending information matched with the current state of the terminal to the base station includes: determining the terminal being in an IDLE state or an INACTIVE state, and sending a third message in a random access process to the base station.

In an embodiment, the terminal is in the IDLE state, and the third message is RRCSetupComplete or RRCReestablishmentComplete; or, the terminal is in the INACTIVE state, and the third message is RRCResumeComplete.

In an embodiment, the sending information matched with the current state of the terminal to the base station includes: determining the terminal being in a CONNECTED state, and sending an RRC (Radio Resource Control) message carrying the wireless charging request to the base station.

In an embodiment, the RRC message is at least one of: UEAssistanceInformation; and defined target information used for carrying the wireless charging request.

In an embodiment, the apparatus further includes:
a configuration receiving module 502 configured to receive charging configuration information sent by the base station; and
a signal receiving module 503 configured to receive, based on the charging configuration information, a signal sent by the base station and used for wireless charging.

FIG. 6 is a schematic block diagram of another charging apparatus 60 shown according to an embodiment of the present disclosure. The charging apparatus shown in the present embodiment is applicable to a base station, and the base station includes, but is not limited to a 4G base station, a 5G base station, and a 6G base station. The base station may communicate with a terminal used as user equipment, and the terminal includes, but is not limited to an electronic device, such as a mobile phone, a tablet computer, a wearable device, a sensor, and an Internet-of-things device. In an embodiment, the terminal may be a terminal applicable to the charging apparatus in any one of above-mentioned embodiments.

As shown in FIG. 6, the charging apparatus may include:

a charging module 601 configured to, receive a wireless charging request sent by a terminal, and perform wireless charging on the terminal.

In an embodiment, the performing wireless charging on the terminal includes: it is determined, based on the current state of the base station, whether wireless charging is performed on the terminal.

In an embodiment, in response to determining, based on the current state of the base station, that wireless charging is performed on the terminal, the apparatus further includes:
a configuration determination module 602 configured to determine charging configuration information on wireless charging for the terminal based on the current state of the base station; and
a charging determination module 603 configured to perform wireless charging on the terminal based on the charging configuration information.

In an embodiment, the current state of the base station includes at least one of: an antenna use condition of the base station; and a load condition of the base station.

In an embodiment, the determining, based on the current state of the base station, whether wireless charging is performed on the terminal includes: determining that wireless charging is not performed on the terminal, wherein the current state is that the number of spare antennae of the base station is less than a preset number threshold; or, determining that wireless charging is not performed on the terminal, wherein the current state is that a load of the base station is greater than a preset load threshold.

In an embodiment, the apparatus further includes:

a configuration sending module 604 configured to send the charging configuration information to the terminal to indicate the terminal to receive, based on the charging configuration information, a signal sent by the base station.

In an embodiment, the charging configuration information includes at least one of: antenna information for wireless charging; time information for wireless charging; and power for wireless charging.

In an embodiment, the sending the charging configuration information to the terminal includes at least one of:
sending an RRCReconfiguration signaling carrying the charging configuration information to the terminal;
sending an RRCSetupComplete signaling carrying the charging configuration information to the terminal;
sending an RRCReestablishmentComplete signaling carrying the charging configuration information to the terminal; and
sending an RRCResumeComplete signaling carrying the charging configuration information to the terminal.

With respect to the apparatus in the above-mentioned embodiment, a specific way in which each module performs an operation has been described in detail in the embodiment of the relevant method, and so as not to be described in detail herein.

The embodiment of the apparatus basically corresponds to the embodiment of the method, and therefore, relevant parts may refer to the description for parts in the embodiment of the method. The above-mentioned embodiment of the apparatus is merely schematic, wherein the modules described as separate components may be or not be physically separated, and components serving as modules may be or not be physical modules, that is, they may be located on the same place or distributed on a plurality of network modules. Parts or all of the modules may be selected according to an actual demand to achieve the purpose of the solution in the present embodiment. The present disclosure may be understood and implemented by those of ordinary skill in the art without creative work.

The specific charging method according to the present disclosure will be generally illustrated below in conjunction with specific technical details:

a cellular network may perform wireless charging on a mobile phone by a base station equipped with large-scale antennae.

When needing the base station to perform wireless charging on the terminal, the terminal sends a signaling to the base station to request the base station to perform wireless charging on the terminal.

If the terminal is a user in an IDLE state:

requesting may be performed by sending a preamble, such as a first message in a random access process. In an embodiment, this preamble may be reserved by the base station for wireless charging.

Requesting may be performed by means of a second message in a random access process, such as RRCSetupRequest or RRCReestablishmentRequest.

Requesting may be performed by means of a third message in a random access process, such as RRCSetupComplete or RRCReestablishmentComplete.

If the terminal is a user in a CONNECTED state:

requesting may be performed by means of a UEAssistanceInformation signaling.

Or, requesting may be performed by introducing a new RadioChargingRequest signaling.

If the terminal is a user in an INACTIVE state:

requesting may be performed by sending a preamble, such as a first message in a random access process. In an embodiment, this preamble may be reserved by the base station for wireless charging.

Requesting may be performed by means of a second message in a random access process, such as RRCResumeRequest.

Requesting may be performed by means of a third message in a random access process, such as RRCResumeComplete.

After receiving the wireless charging request, the base station decides whether to perform wireless charging and/or how to perform wireless charging on this terminal according to its own actual condition, and sends a configuration signaling for configuration.

The base station may decide whether/how to configure wireless charging according to its own antenna use condition, for example, the number of spare antennae of the base station is not enough to support wireless charging.

The base station may decide whether/how to configure wireless charging according to its own load condition.

This configuration signaling may be an RRC signaling, an MAC layer signaling or a PHY layer signaling, for example, it may be an RRCReconfiguration signaling or an RRCSetupComplete signaling or an RRCReestablishmentComplete signaling or an RRCResumeComplete signaling.

An embodiment of the present disclosure further provides an electronic device, including:
a processor; and
a memory configured to store an instruction executable for the processor;
wherein the processor is configured to implement the charging method in the above-mentioned embodiment.

An embodiment of the present disclosure further provides a computer-readable storage medium, having a computer program stored thereon, wherein the charging method in the above-mentioned embodiment is implemented when this program is executed by a processor.

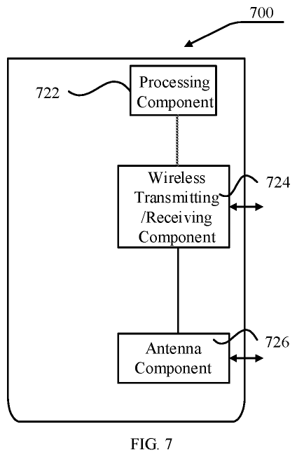

As shown in FIG. 7, FIG. 7 is a schematic block diagram of an apparatus for charging shown according to an embodiment of the present disclosure. The apparatus 700 may be provided as a base station. With reference to FIG. 7, the apparatus 700 includes a processing component 722, a wireless transmitting/receiving component 724, an antenna component 726, and a unique signal processing part of a wireless interface, wherein the processing component 722 may further include one or more processors. One of the processors in the processing component 722 may be configured to implement the charging method.

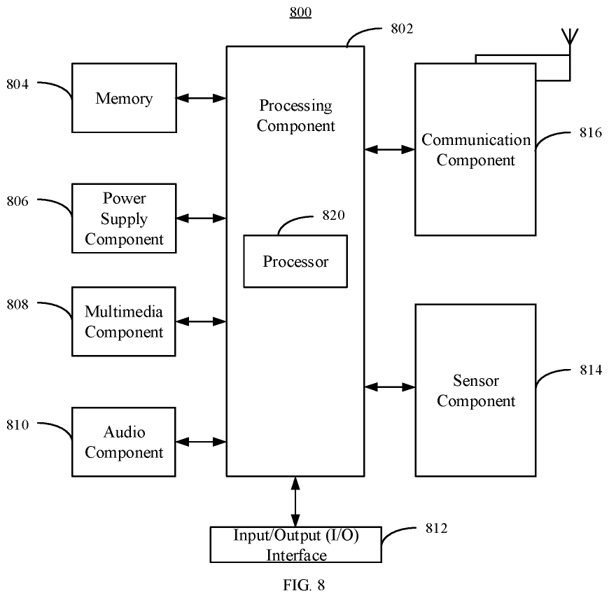

FIG. 8 is a schematic block diagram of an apparatus for charging shown according to an embodiment of the present disclosure. For example, the apparatus 800 may be a mobile phone, a computer, a digital broadcasting terminal, a message receiving and sending device, a game console, a tablet device, a medical device, a fitness device, a personal digital assistant, etc.

With reference to FIG. 8, the apparatus 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation, such as operation relevant to display, telephone call, data communication, camera operation and record operation, of the apparatus 800. The processing component 802 may include one or more processors 820 to execute instructions, so as to complete all or parts of the steps of the above-mentioned charging method. In addition, the processing component 802 may include one or more modules, thereby facilitating the interaction between the processing component 802 and each of other components. For example, the processing component 802 may include a multimedia module, so as to facilitate the interaction between the multimedia component 808 and the processing component 802.

The memory 804 is configured to store various types of data, so as to support operations on the apparatus 800. Examples of the data include instructions for operating any application or method on the apparatus 800, contact data, telephone book data, messages, pictures, videos, etc. The memory 804 may be achieved by any types of volatile or non-volatile storage devices or combinations thereof, such as a static random access memory (SRAM), an electrically erasable programmable read-only memory (EEPROM), an erasable programmable read-only memory (EPROM), a programmable read-only memory (PROM), a read only memory (ROM), a magnetic memory, a flash memory, a magnetic disk or an optical disk.

The power supply component 806 provides power for various components of the apparatus 800. The power supply component 806 may include a power management system, one or more power supplies, and other components relevant to the generation, management and power distribution of the apparatus 800.

The multimedia component 808 includes a screen providing an output interface between the apparatus 800 and a user. In some embodiments, the screen may include a liquid crystal display (LCD) and a touch panel (TP). If the screen includes the touch panel, the screen may be implemented as a touch screen, so as to receive an input signal from the user. The touch panel includes one or more touch sensors to sense touch, sliding and gestures on the touch panel. The touch sensors may not only sense a boundary of a touch or sliding action, but also detect duration and pressure relevant to the touch or sliding operation. In some embodiments, the multimedia component 808 includes a front camera and/or a rear camera. When the apparatus 800 is in an operating mode, such as a shooting mode or a video mode, the front camera and/or the rear camera may receive external multimedia data. Each front camera and rear camera may be a fixed optical lens system or have a focal length and an optical zooming ability.

The audio component 810 is configured to output and/or input an audio signal. For example, the audio component 810 includes a microphone (MIC), and when the apparatus 800 is in the operating mode, such as a call mode, a record mode, and a voice recognition mode, the microphone is configured to receive an external audio signal. The received audio signal may be further stored in the memory 804 or sent by the communication component 816. On some embodiments, the audio component 810 further includes a loudspeaker for outputting an audio signal.

The I/O interface 812 is provided between the processing component 802 and a peripheral interface module, and the above-mentioned peripheral interface module may be a keyboard, a click wheel, buttons, etc. These buttons may include, but are not limited to: a home button, a volume button, a start button, and a lock button.

The sensor component 814 includes one or more sensors configured to provide state evaluation in various aspects for the apparatus 800. For example, the sensor component 814 may detect an on/off state of the apparatus 800 and relative positioning of the components, for example, the components are a display and a keypad of the apparatus 800. The sensor component 814 may further detect the position change of the apparatus 800 or a component of the apparatus 800, the existence or inexistence of contact between a user and the apparatus 800, the direction or acceleration/deceleration of the apparatus 800, and the temperature change of the apparatus 800. The sensor component 814 may include a proximity sensor configured to detect the existence of a nearby object when there is no any physical contact. The sensor component 814 may further include an optical sensor, such as a CMOS or CCD image sensor configured to be used in imaging applications. In some embodiments, this sensor component 814 may further include an acceleration sensor, a gyroscope sensor, a magnetic sensor, a pressure sensor or a temperature sensor.

The communication component 816 is configured to facilitate communication in a wired or wireless manner between the apparatus 800 and each of other devices. The apparatus 800 may be connected to a wireless network based on a communication standard, such as WiFi, 2G or 3G, 4G LTE, 5G NR or combinations thereof. In an exemplary embodiment, the communication component 816 receives a broadcast signal or broadcast-relevant information from an external broadcast management system by means of a broadcast channel. In an exemplary embodiment, the communication component 816 further includes a near-field communication (NFC) module, so as to promote short-range communication. For example, the NFC module may be implemented based on a radio frequency identification device (RFID) technology, an infrared data association (IrDA) technology, an ultra-wide bandwidth (UWB) technology, a Bluetooth (BT) technology and other technologies.

In an exemplary embodiment, the apparatus 800 may be implemented by one or more application specific integrated circuits (ASIC), a digital signal processor (DSP), a digital signal processing device (DSPD), a programmable logic device (PLD), a field programmable gate array (FPGA), a controller, a micro-controller, a microprocessor or other electronic elements, and is used for performing the above-mentioned charging method.

In an exemplary embodiment, further provided is a non-temporary computer-readable storage medium including an instruction, such as a memory 804 including an instruction, and the above-mentioned instruction may be executed by the processors 820 of the apparatus 800 to complete the above-mentioned charging method. For example, the non-temporary computer-readable storage medium may be an ROM, a random access memory (RAM), a CD-ROM, a magnetic tape, a floppy disk, an optical data storage device, etc.

Other implementation solutions will be readily envisioned by those skilled in the art after considering the description and putting the present disclosure disclosed herein into practice. The present disclosure aims at covering any variations, purposes or adaptive changes of the present disclosure, and these variations, purposes or adaptive changes conform to a general principle of the present disclosure and include common general knowledge or conventional technical means in the undisclosed technical field of the present disclosure. The description and the embodiments are merely regarded to be exemplary, and the true scope and spirit of the present disclosure are appointed by the following claims.

It should be understood that the present disclosure is not limited to precise structures which have been described above and shown in the accompanying drawings, and various modifications and alterations may be made without departing from the scope thereof. The scope of the present disclosure is merely limited by the appended claims.

It should be noted that relational terms such as first and second described herein are merely used to distinguish one entity or operation from another one, but do not necessarily require or imply the presence of any such actual relationship or order between these entities or operations. Terms “includes”, “including” or any other variants thereof are intended to cover non-excludable inclusion, so that a process, method, article or device including a series of elements not only includes those elements, but also includes other elements not listed clearly, or further includes inherent elements of the process, method, article or device. In a case that there are no more limitations, elements defined by the word “including a . . . ” do not exclude other same elements further existing in the process, method, article or device including the elements.

The method and apparatus provided according to the embodiments of the present disclosure have been introduced above in detail. The principle and implementations of the present disclosure have been described by applying specific examples in the present disclosure, and the description for the above-mentioned embodiments is merely intended to help the understanding of the method and a core concept thereof in the present disclosure. At the same time, those of ordinary skill in the art may make modifications on specific implementations and application scopes according to the concept of the present disclosure. In conclusion, the contents of the present description should not be understood as limitations of the present disclosure.

According to an aspect of the embodiments of the present disclosure, a charging method performed by a terminal comprises: sending a wireless charging request to a base station to request the base station to perform wireless charging on the terminal.

In some examples, the sending a wireless charging request to a base station comprises: sending information matched with a current state of the terminal to the base station, wherein the information carries the wireless charging request.

In some examples, the sending information matched with a current state of the terminal to the base station comprises: determining the terminal being in an IDLE state or an INACTIVE state, and sending a specified preamble to the base station, wherein the specified preamble is configured to indicate the base station to perform wireless charging on the terminal.

In some examples, the sending a specified preamble to the base station comprises: sending a first message in a random access process carrying the specified preamble to the base station.

In some examples, the sending information matched with a current state of the terminal to the base station comprises: determining the terminal being in an IDLE state or an INACTIVE state, and sending a second message in a random access process to the base station.

In some examples, the terminal is in the IDLE state, and the second message is RRCSetupRequest or RRCReestablishmentRequest; or, the terminal is in the INACTIVE state, and the second message is RRCResumeRequest.

In some examples, the sending information matched with a current state of the terminal to the base station comprises: determining the terminal being in an IDLE state or an INACTIVE state, and sending a third message in a random access process to the base station.

In some examples, the terminal is in the IDLE state, and the third message is RRCSetupComplete or RRCReestablishmentComplete; or, the terminal is in the INACTIVE state, and the third message is RRCResumeComplete.

In some examples, the sending information matched with a current state of the terminal to the base station comprises: determining the terminal being in a CONNECTED state, and sending a radio resource control (RRC) message carrying the wireless charging request to the base station.

In some examples, the RRC message is at least one of: UE assistance information; or defined target information for carrying the wireless charging request.

In some examples, the method further comprises: receiving charging configuration information sent by the base station; and receiving, based on the charging configuration information, a signal sent by the base station and for wireless charging.

According to an aspect of the embodiments of the present disclosure, a charging method performed by a base station comprises: receiving a wireless charging request sent by a terminal, and performing wireless charging on the terminal.

In some examples, the performing wireless charging on the terminal comprises: determining, based on a current state of the base station, whether wireless charging is performed on the terminal.

In some examples, determining, based on the current state of the base station, that wireless charging is performed on the terminal, the method further comprises: determining charging configuration information on wireless charging for the terminal based on the current state of the base station; and performing wireless charging on the terminal based on the charging configuration information.

In some examples, the current state of the base station comprises at least one of: an antenna use condition of the base station; or a load condition of the base station.

In some examples, the determining, based on a current state of the base station, whether wireless charging is performed on the terminal comprises: determining that wireless charging is not performed on the terminal, wherein the current state is that a number of spare antennae of the base station is less than a preset number threshold; or, determining that wireless charging is not performed on the terminal, wherein the current state is that a load of the base station is greater than a preset load threshold.

In some examples, the method further comprises: sending the charging configuration information to the terminal to indicate the terminal to receive, based on the charging configuration information, a signal sent by the base station.

In some examples, the charging configuration information comprises at least one of: antenna information for wireless charging; time information for wireless charging; or power for wireless charging.

In some examples, the sending the charging configuration information to the terminal comprises at least one of: sending an RRCReconfiguration signaling carrying the charging configuration information to the terminal; sending an RRCSetupComplete signaling carrying the charging configuration information to the terminal; sending an RRCReestablishmentComplete signaling carrying the charging configuration information to the terminal; and sending an RRCResumeComplete signaling carrying the charging configuration information to the terminal.

According to an aspect of the embodiments of the present disclosure, an electronic device comprises: a processor; and a memory configured to store instructions executable by the processor; wherein the processor is configured to implement the charging method in the the above-mentioned aspect.

According to an aspect of the embodiments of the present disclosure, a computer-readable storage medium, having a computer program stored thereon, wherein the steps in the charging method in the above-mentioned aspect are implemented when the program is executed by a processor.

1. A charging method, performed by a terminal, the method comprising:
sending a wireless charging request to a base station to request the base station to perform wireless charging on the terminal.

2. The method according to claim 1, wherein the sending a wireless charging request to a base station comprises:
sending information matched with a current state of the terminal to the base station, wherein the information carries the wireless charging request.

3. The method according to claim 2, wherein the sending information matched with a current state of the terminal to the base station comprises:
determining the terminal being in an idle state or an inactive state, and sending a specified preamble to the base station, wherein the specified preamble is configured to indicate the base station to perform wireless charging on the terminal.

4. The method according to claim 3, wherein the sending a specified preamble to the base station comprises:
sending a first message in a random access process carrying the specified preamble to the base station.

5. The method according to claim 2, wherein the sending information matched with a current state of the terminal to the base station comprises:
determining the terminal being in an idle state or an inactive state, and sending a second message in a random access process to the base station.

6. The method according to claim 5, wherein
the terminal is in the idle state, and the second message is RRCSetupRequest or RRCReestablishmentRequest; or,
the terminal is in the inactive state, and the second message is RRCResumeRequest.

7. The method according to claim 2, wherein the sending information matched with a current state of the terminal to the base station comprises:
determining the terminal being in an idle state or an inactive state, and sending a third message in a random access process to the base station.

8. The method according to claim 7, wherein
the terminal is in the idle state, and the third message is RRCSetupComplete or RRCReestablishmentComplete; or,
the terminal is in the inactive state, and the third message is RRCResumeComplete.

9. The method according to claim 2, wherein the sending information matched with a current state of the terminal to the base station comprises:
determining the terminal being in a connected state, and sending a radio resource control (RRC) message carrying the wireless charging request to the base station.

10. The method according to claim 9, wherein the RRC message is at least one of:
User equipment (UE) assistance information; or
defined target information for carrying the wireless charging request.

11. The method according to claim 1, wherein the method further comprises:
receiving charging configuration information sent by the base station; and
receiving, based on the charging configuration information, a signal sent by the base station and for wireless charging.

12. A charging method, performed by a base station, and the method comprising:
receiving a wireless charging request sent by a terminal, and performing wireless charging on the terminal.

13. The method according to claim 12, wherein the performing wireless charging on the terminal comprises:
determining, based on a current state of the base station, whether wireless charging is performed on the terminal.

14. The method according to claim 13, wherein determining, based on the current state of the base station, that wireless charging is performed on the terminal, the method further comprises:
determining charging configuration information on wireless charging for the terminal based on the current state of the base station; and
performing wireless charging on the terminal based on the charging configuration information.

15. The method according to claim 13, wherein the current state of the base station comprises at least one of:
an antenna use condition of the base station; or
a load condition of the base station.

16. The method according to claim 15, wherein the determining, based on a current state of the base station, whether wireless charging is performed on the terminal comprises:
determining that wireless charging is not performed on the terminal, wherein the current state is that a number of spare antennae of the base station is less than a preset number threshold;
or,
determining that wireless charging is not performed on the terminal, wherein the current state is that a load of the base station is greater than a preset load threshold.

17. The method according to claim 14, wherein the method further comprises:
sending the charging configuration information to the terminal to indicate the terminal to receive, based on the charging configuration information, a signal sent by the base station.

18. The method according to claim 14, wherein the charging configuration information comprises at least one of:
antenna information for wireless charging;
time information for wireless charging; or
power for wireless charging.

19. The method according to claim 17, wherein the sending the charging configuration information to the terminal comprises at least one of:
sending an RRCReconfiguration signaling carrying the charging configuration information to the terminal;
sending an RRCSetupComplete signaling carrying the charging configuration information to the terminal;
sending an RRCReestablishmentComplete signaling carrying the charging configuration information to the terminal; and
sending an RRCResumeComplete signaling carrying the charging configuration information to the terminal.

20. (canceled)

21. (canceled)

22. An electronic device, comprising:
a processor; and
a memory configured to store instructions executable by the processor;
wherein the processor is configured to;
send a radio charging request to a base station to request the base station to perform radio charging on the terminal.

23. (canceled)
